(19) United States
(12) Patent Application Publication
(10) Pub. No.: US 2025/0058540 A1
(43) Pub. Date: Feb. 20, 2025

(54) MODULAR PRESS BRAKE HAVING IMPROVED COMPONENTS AND ACCESSORIES

(71) Applicant: 2446914 ONTARIO INC., Vars (CA)

(72) Inventors: Alexandre CLOUTIER, Orleans (CA); Alexandre DUMAS, Gatineau (CA); Simon BÉLANGER, Rockland (CA); Gabriel BRENNAN, Rockland (CA)

(73) Assignee: 2446914 ONTARIO INC., Vars, ON (CA)

(21) Appl. No.: 18/719,996

(22) PCT Filed: Dec. 14, 2022
(86) PCT No.: PCT/CA2022/051831

§ 371 Date: Jun. 14, 2024

Related U.S. Application Data
(60) Provisional application No. 63/289,887, filed on Dec. 15, 2021.

(51) Int. Cl. B30B 15/10; B21D 5/04; B30B 15/04

(52) U.S. Cl. CPC B30B 15/10; B21D 5/042; B30B 15/04

(57) ABSTRACT

The present disclosure provides a method to assemble castings for use in a press brake. A modular press brake is also provided, the modular press brake having a socket connection between the base rail and the bending rail. The press brake is also comprised of a measuring tool having a magnet to engage and disengage from the press brake. An extension allows for cutters to travel from the press brake onto the extension and better cut or bend wider sheet metal. The press brake may be comprised of a stopper pivotable about an axis to quickly prevent or allow the passage of sheet metal in the press brake. The modular press brake is comprised of rails, extruded and fitted into one another. Adjacent rails can be secured to one another by means of fasteners, such that the press brake can be of any length as desired.

### FIELD

The disclosure relates to the field of construction, and more specifically to a modular press brake having improved components and accessories.

### BACKGROUND

Press brakes have been around for decades without much innovation. They are bulky and heavy, which makes it difficult to store them, manufacture them, or ship them efficiently. Further, their accessories are old and inefficient, so there is great room for improvement.

More specifically, the present press brake has been designed to be modular and lightweight, therefore easy and affordable to manufacture and ship to a destination. Indeed, smaller manual press brakes are comprised of “castings” (i.e. “arms” or “frames”) a word that is used in the art because the arms are cast in a single, heavy piece of metal. In the present design, the castings are made of two opposed C-plates (“C-frames”), that can be manufactured in light sheets to be reassembled at the destination. Further, the press brake is modular; all pieces are designed to fit together along their length to reduce shipping costs and increase the ease of assembly. Such an improved design would allow the user to expand or shrink the length of the press brake based on need. The modular press brake is also comprised of an improved socket connection, a measuring tool, a stopper and an adaptable and modular extension.

### SUMMARY

In an aspect, the present disclosure provides a press brake comprising: at least one base rail; at least one bending rail operatively connected to the at least one base rail for bending materials; at least one locking rail engageable with the bending rail to lock the material in the press brake; at least two castings releasably secured to the at least one base rail and at least one support bar; an arm secured to each one of the at least two castings and connecting the at least two castings to the at least one locking rail; a locking handle connected to each one of the at least two castings, the locking handle actuatable to lock the press brake; and, a socket connection between the base rail and the bending rail.

In another aspect, the present disclosure provides a method to assemble a casting, the method comprising the steps of: aligning apertures of a first plate of the casting with bolts and placing the first plate on the bolts through the apertures; aligning first projections of spacers, an adjustment arm and a locking arm, over the first plate and inserting the projections of the spacers, the adjustment arm and the locking arm through receiving openings of the spacers, adjustment arm and locking arm; aligning holes of a second plate of the casting with second opposed projections of the spacers, the adjustment arm and the locking arm and inserting the second opposed projections into the holes to properly position the second plate; securing the bolts with a fastener to sandwich the spacers, the adjustment arm and the locking arm into place.

In yet another aspect, the present disclosure provides a stopper for use with a press brake comprising: a clamp to slidably secure the stopper to the press brake; a rail pivotably connected to the clamp; and, a stopping member slidable along the rail, wherein the stopping member can be pivoted with the rail to prevent obstruction of a material in the press brake.

In another aspect, the present disclosure provides a measuring tool for use in press brakes comprising: a measuring portion terminating in an arm portion; a magnet positioned in the arm portion to magnetically engage with the press brake; and, a recess engageable with the press brake to support the measuring tool.

In another aspect, the present disclosure provides an extension for a press brake comprising: a sheet member; a bar; and, a fastener to removably secure the extension to the press brake; wherein the sheet member creates a continuous surface and a continuous plane on which cutters can slide from the press brake to the extension and back.

In yet another aspect, the present disclosure provides a stopper for use with a press brake comprising: a clamp to slidably secure the stopper to the press brake; a rail pivotably connected to the clamp; and, a stopping member slidable along the rail, wherein the stopping member can be pivoted with the rail to prevent obstruction of a material in the press brake.

### BRIEF DESCRIPTION OF THE DRAWINGS

The following figures serve to illustrate various embodiments of features of the disclosure. These figures are illustrative and are not intended to be limiting.

FIG. 1 is a perspective view of a modular press brake having improved C-frames, according to an embodiment of the present disclosure;

FIG. 2 is a perspective of the C-frame of FIG. 1, according to an embodiment of the present disclosure;

FIG. 3A is an enlarged perspective view of an adjustment arm interconnected to a clamp member of the C-frame of FIG. 1, according to an embodiment of the present disclosure;

FIG. 3B is another enlarged perspective view of the adjustment arm interconnected to the clamp member of the C-frame of FIG. 1, according to an embodiment of the present disclosure;

FIG. 4 is a first perspective view of a stopper for use in press brakes, according to an embodiment of the present disclosure;

FIG. 5 is a second perspective view of the stopper of FIG. 4, according to an embodiment of the present disclosure;

FIG. 6 is a perspective view of a measuring tool connectable to the modular press brake of FIG. 1, according to an embodiment of the present disclosure;

FIG. 7 is a side cross-sectional view of a socket connection of the modular press brake and the measuring tool connected to the bending rail of FIG. 6, according to an embodiment of the present disclosure;

FIG. 8 is a side cross-sectional view of the socket connection of FIG. 7 as the bending rail is partially pivoted counterclockwise, according to an embodiment of the present disclosure;

FIG. 9 is a side cross-sectional view of the socket connection of FIG. 7 as the bending rail is fully pivoted counterclockwise, according to an embodiment of the present disclosure;

FIG. 10 is an enlarged side cross-sectional view of the socket connection in the position shown in FIG. 8, according to an embodiment of the present disclosure;

FIG. 11 is a front perspective view of an extension for a locking rail of a press brake, according to an embodiment of the present disclosure;

FIG. 12 is a rear perspective view of the extension shown in FIG. 11, according to an embodiment of the present disclosure;

FIG. 13 is a front perspective view of the extension shown in FIG. 11 having cutters sliding thereon, according to an embodiment of the present disclosure;

FIG. 14 is another front perspective view of the extension shown in FIG. 11 having cutters sliding thereon, according to an embodiment of the present disclosure;

FIG. 15 is a front perspective view of an extension for another type of locking rail of a press brake, according to another embodiment of the present disclosure;

FIG. 16 is a rear perspective view of the extension shown in FIG. 15, according to another embodiment of the present disclosure;

FIG. 17 is a front perspective view of the extension shown in FIG. 15 having cutters sliding thereon, according to an embodiment of the present disclosure;

FIG. 18 is another front perspective view of the extension shown in FIG. 15 having cutters sliding thereon, according to an embodiment of the present disclosure;

FIG. 19A is a perspective view of the C-frame shown in FIG. 1, according to an embodiment of the present disclosure;

FIG. 19B is a perspective of a C-frame having a first varied depth, according to another embodiment of the present disclosure;

FIG. 19C is a perspective of a C-frame having a second varied depth, according to another embodiment of the present disclosure;

FIG. 20 is a rear perspective view of a modular press brake, according to another embodiment of the present disclosure;

FIG. 21 is an upper front perspective view of the modular press brake shown in FIG. 20;

FIG. 22 is an enlarged perspective view of a clamp and a tri clamp secured to the modular press brake shown in FIG. 20;

FIG. 23 is an enlarged cross-sectional view of base, bending and locking rails of the modular press brake shown in FIG. 20;

FIG. 24 is an enlarged cross-sectional perspective view of a casting secured to a stabilizing arm of the modular press brake shown in FIG. 20;

FIG. 25 is another enlarged cross-sectional perspective view of a casting secured to a stabilizing arm of the modular press brake shown in FIG. 20;

FIG. 26 is an enlarged perspective view of a stabilizing arm of the modular press brake shown in FIG. 20;

FIG. 27 is an enlarged perspective view of a casting of the modular press brake shown in FIG. 20;

FIG. 28 is an underside perspective view of the bending rails of the modular press brake shown in FIG. 20;

FIG. 29 is a perspective view of a pincer of a modular press brake, according to another embodiment of the present disclosure;

FIG. 30A is a perspective view of the pincer of FIG. 29 secured to a base rail, according to another embodiment of the present disclosure;

FIG. 30B is a perspective view of a fastener secured to a locking rail, according to another embodiment of the present disclosure;

FIG. 31A is a perspective view of connecting bars positioned within a locking rail, according to another embodiment of the present disclosure;

FIG. 31B is a perspective view of the connecting bars of FIG. 31A to secure a locking rail to an adjacent locking rail;

FIG. 32A is a perspective view of a reversible bending mechanism of a press brake in the pull-to-lock position, according to another embodiment of the present disclosure;

FIG. 32B is a rear perspective view of the reversible bending mechanism of FIG. 32A;

FIG. 32C is a rear perspective view of the reversible bending mechanism of FIG. 32A;

FIG. 32D is a side view of the reversible bending mechanism of FIG. 32A;

FIG. 33A is a perspective view of a reversible bending mechanism of a press brake in the push-to-lock position, according to another embodiment of the present disclosure;

FIG. 33B is a rear perspective view of the reversible bending mechanism of FIG. 33A;

FIG. 33C is a rear perspective view of the reversible bending mechanism of FIG. 33A;

FIG. 33D is a side view of the reversible bending mechanism of FIG. 33A;

FIG. 34 is a perspective view of a connector to secure two adjacent rails, according to another embodiment of the present disclosure;

FIG. 35 is a perspective view of a connector to secure two adjacent bars, according to yet another embodiment of the present disclosure;

FIG. 36 is a perspective view of a connector to secure two adjacent bars, according to yet another embodiment of the present disclosure;

FIG. 37A is a perspective view of a fastener to secure a bar to a structure, according to yet another embodiment of the present disclosure;

FIG. 37B is a cross-sectional view of the fastener of FIG. 37A.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

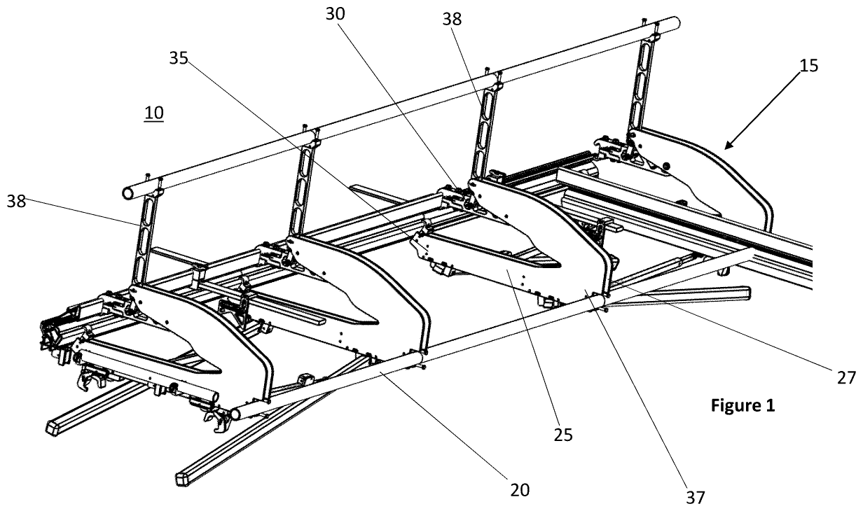

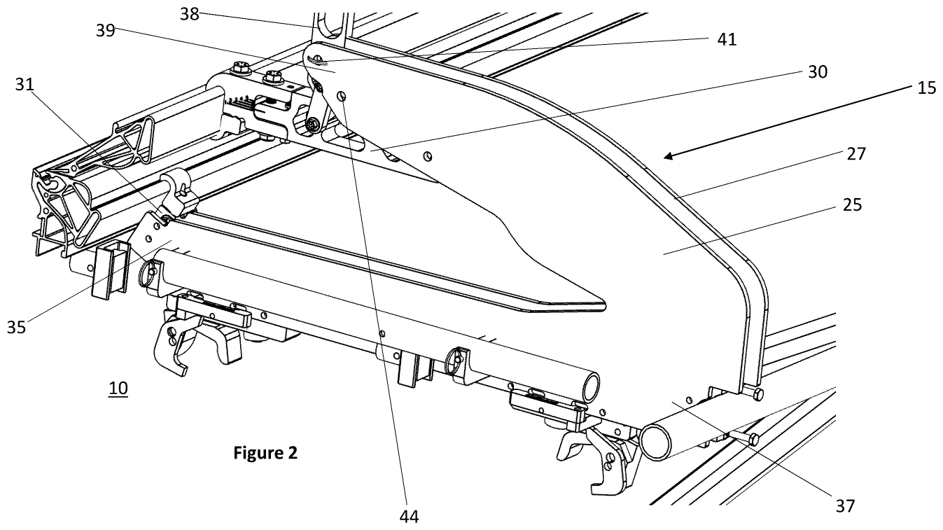

With reference to FIGS. 1, 2, 3A and 3B and according to an embodiment of the present disclosure, a modular press brake 10 is shown. The press brake 10 is further comprised of a plurality of C-frames 15 positioned along a support bar 20. A worker skilled in the art would appreciate that in a common press brake used in the art, castings are cast as single-piece members. In contrast, the present C-frames 15 are further comprised of two opposed plates 25, 27, secured to one another by means of bolts, screws or other suitable means. The plates 25, 27 are separated by at least an adjustment arm 30 and a pincer 31 that act as spacers in between the plates 25, 27. It is a problem in the art that castings are heavy, bulky and are susceptible to breaking. The present C-frames 15 primarily comprised of two opposed plates 25, 27 allows easy assembly of the press brake 10 as well as simpler shipping and servicing of the press brake 10 or C-frames 15. The C-frames 15 are also lighter and more rigid than conventional castings used in the art. The two opposed plates 25, 27 also allows a greater throat depth of the C-frames 15. During manufacturing and assembly of the present C-frames 15, a first step is to create the two opposed plates 25, 27 by cutting sheet metal to a desired shape. In a second step, spacers (not shown) are positioned and secured in between the two opposed plates 25, 27. The spacers (not shown) are preferably positioned at front and rear ends 35, 37 of the C-frames 15, where clamping and fastening of the C-frames 15 to the press brake 10 is required. In a third step, a locking handle or arm 38 is positioned at a top end 39 of the C-frames 15. The locking arm 38 also acts as an additional spacer therebetween. In a fourth step, a plurality of nuts and bolts (not shown) are secured to each of the two opposed plates 25, 27 to sandwich them together. A worker skilled in the art would appreciate that in an operating position of the press brake 10, a locking pin 41 is positioned through an upper aperture (not shown) at the top end 39 of the two opposed plates 25, 27 and through the locking arm 38. Meanwhile during storage or shipping of the press brake 10, the locking pin 41 is removed and the locking arm 38 is pivoted downwardly in between the two opposed plates 25, 27. The locking pin 41 is then inserted through a lower aperture 44 of the two opposed plates 25, 27 and again through the locking arm 38, thereby locking the locking arm 38 in this storage or shipping position. In an optional method of assembly, an assembly jig (not shown) may be provided, configured to receive the C-frames 15. Alternatively, the assembly jig is not utilized, and the components are comprised of various projections corresponding to apertures, which are aligned to one another and assembled accordingly. In a first step, bolts (not shown) or dowels (not shown) are positioned thread up on the assembly jig (not shown) or on another receiving surface. In a second step, the first plate 25 is positioned and over the bolts (not shown), aligning the bolts with holes (not shown) of the plate 25. In a third step, spacers (not shown) are positioned over the bolts (not shown) at the front and rear ends 35, 37 of the C-frames 15. In a fourth step, the adjustment arm 30, a locking arm 38 and pincer 31 are positioned over the bolts (not shown), again aligning the holes of the arms 30, 38 and pincer 31 with the bolts. In a fifth step, the second plate 27 is positioned over the bolts (not shown), sandwiching the spacers (not shown), adjustment and locking arms 30, 38 and pincer 31 in between each of the first and second opposed plates 25, 27. In a sixth step, the nuts (not shown) are loosely threaded onto the bolts (not shown). In a seventh step, the locking arm 38 is rotated to a locked position, such locked position to lock sheet metal in place. Such motion of the locking arm 38 correspondingly displaces the adjustment arm 30, which tightens against the nuts and bolts (not shown) and the first and second opposed plates 25, 27. The tightening of the arms 30, 38 against the nuts and bolts (not shown) removes “slack” of the nuts and bolts (not shown) to ensure optimal fitting and assembly. Once the locking arm 38 is in this locked position, the nuts and bolts (not shown) can be tightened in place. First and second brackets 51, 52 are shown, secured to both the adjustment arm 30 and the locking arm 38. A first bolt 53 is secured through the first and second brackets 51, 52 and the adjustment arm 30, while a second bolt 54 is secured through the first and second brackets 51, 52 and the locking arm 38. The first and second brackets 51, 52 pivot to allow pivoting of the locking arm 38 relative to the adjustment arm 30. As shown, a lower end 46 of the locking arm 38 abuts against an upper surface 48 of the adjustment arm 30 when the locking arm 38 is in the locked position. At the same time, first indentation 49 of the plate 25 and second indentation (not shown) of the plate 27, abut against first and second brackets 51, 52, respectively. It is an advantage of the present disclosure that when the locking arm 38 abuts against the adjustment arm 30, and the first and second brackets 51, 52 abut against the opposed plates 25, 27 when the locking arm 38 is in the locked position, shear pressure that would otherwise be present on the bolts 53, 54 is alleviated.

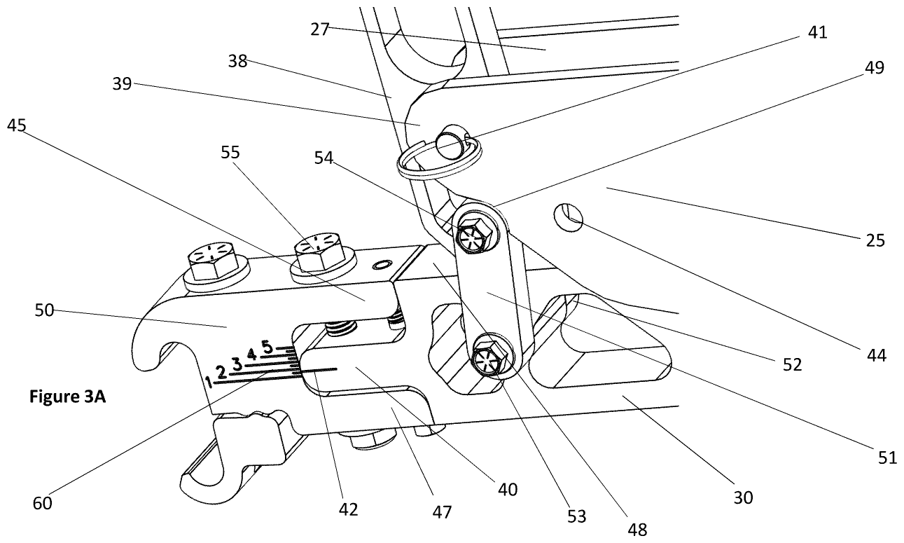

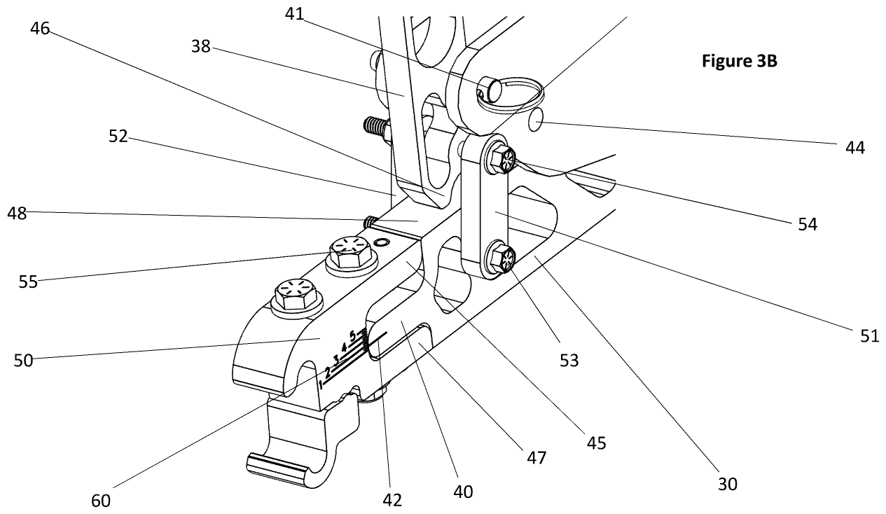

With further reference to FIGS. 3A and 3B and according to an embodiment of the present disclosure, the adjustment arms 30 terminate in a protruding member 40 having a notch 42. The protruding member 40 is trapped in between two opposed positioning arms 45, 47 of a clamp member 50. An adjustment bolt 55 is threaded through each of the positioning arms 45, 47 and through the protruding member 40. A worker skilled in the art is able to adjust the height of the protruding member 40, and by extension, the adjustment arm 30, by rotating the adjustment bolt 55. Indeed, by rotating the adjustment bolt 55, the threads of the adjustment bolt 55 engage with the protruding member 40 such that the protruding member 40 slides up or down the adjustment bolt 55. As the locking handle or arm 38 is connected to the positioning arm 30, an operator can adjust the pressure applied onto sheet metal when the press brake 10 is in the locked position. The clamp member 50 is further comprised of visual indicators 60 that can align with the notch 42 of the protruding member 40 and aid the operator to determine the desired pressure against the sheet metal, to account for varying thicknesses thereof. The visual indicators 60 also ensure accurate and consistent setting across all pairs of C-frames (not shown) as may be used in the press brake (not shown).

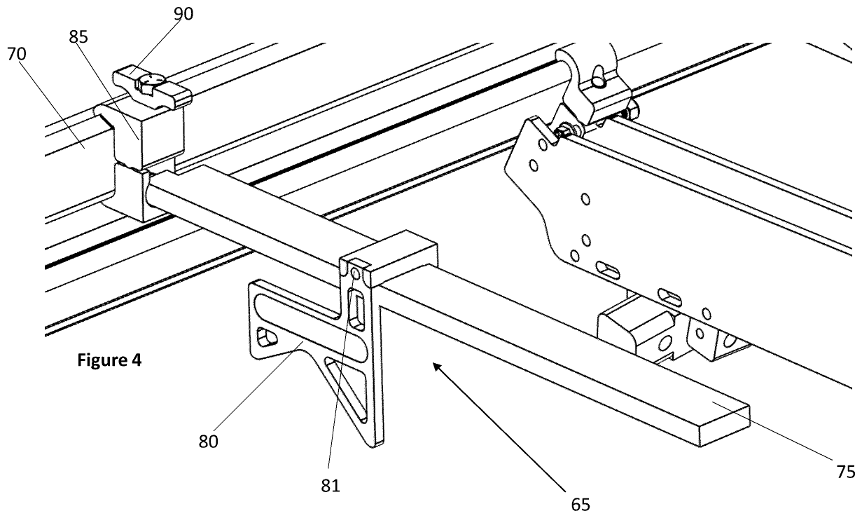

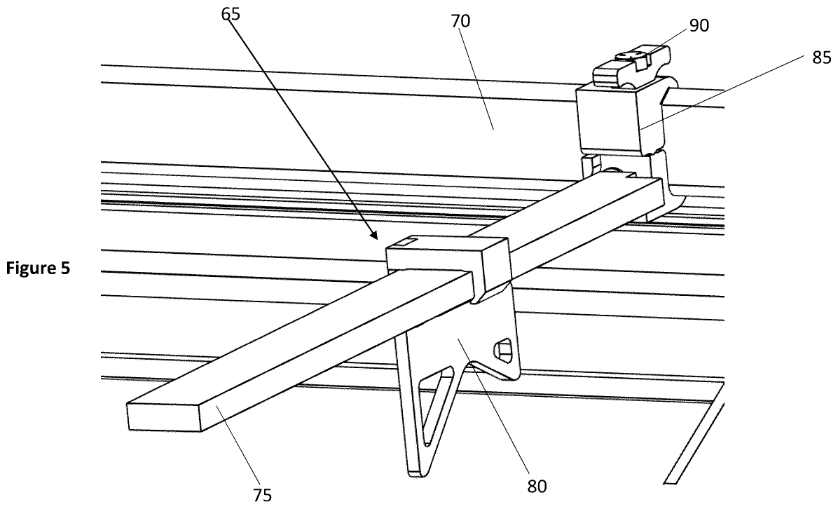

With reference to FIGS. 4 and 5 and according to an embodiment of the present disclosure, a stopper 65 is shown moveably secured to a locking rail 70 of the press brake 10. The stopper 65 is further comprised of a rail 75 and a stopping member 80 slidable along the rail 75. The stopping member 80 is utilized to stop a layer of sheet metal (not shown) from advancing further into the press brake 10. The rail 75 is pivotably connected to a clamp 85, the clamp 85 slidable along the locking rail 70. The clamp 85 has a tightening bolt 90 to be loosened and tightened over the locking rail 70. The stopper 65 is further comprised of a thrust bearing (not shown) secured within the clamp 85 and connected to the rail 75, such that the rail 75 can be rotated 90-degrees counterclockwise. This allows an operator of the press brake 10 to quickly rotate the rail 75 so that the rail 75 and stopping member 80 no longer obstruct the sheet metal when adjustments need to be made, as opposed to having to remove or disconnect the stopper 65 from the press brake entirely. In an embodiment, the stopper 65 may be comprised of measuring units (not shown) etched or stuck onto an upper surface of the rail 75 to provide a visual aid for an operator in determine an appropriate length. A worker skilled in the art would appreciate that a wing bolt (not shown) would be provided and fitted through opening 81 to tighten or loosen the stopper 80 along the rail 75.

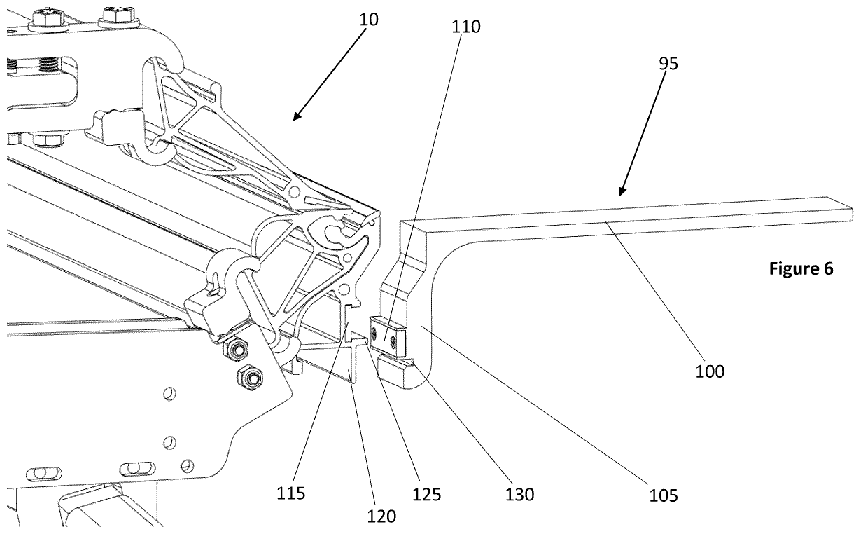

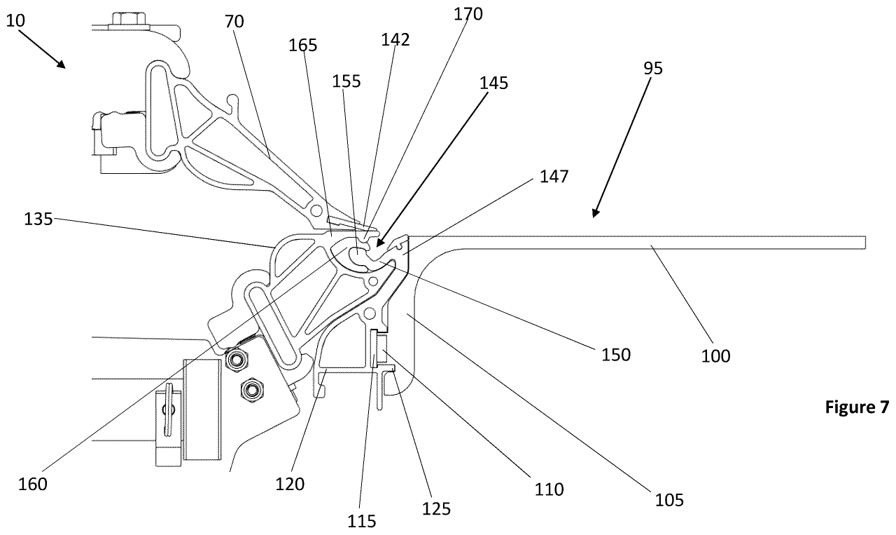

With reference to FIGS. 6 and 7 and according to an embodiment of the present disclosure, a measuring tool 95 is shown. The measuring tool 95 is further comprised of a measuring portion 100 to help an operator of the press brake 10 to determine an appropriate length of material to bend. The measuring portion 100 is preferably comprised of measurement units (not shown) etched or stuck on the top surface of the measuring portion 100. Such measuring units (not shown) would further help an operator of the press brake 10 to determine an appropriate length of material to bend. The measuring portion 100 terminates in an arm portion 105, the arm portion 105 having at least one magnet 110. The magnet 110 is magnetically engageable with a strip 115 positioned in the bending rail 120 of the press brake 10. With specific reference to FIG. 7, the measuring tool 95 is magnetically engaged with the bending rail 120. The bending rail 120 is further comprised of a lip 125 engageable with a recess 130 positioned on the arm porting 105 of the measuring tool 95. When the measuring tool 95 is engaged with the bending rail 120, the lip 125 is necessarily inserted into the recess 130, providing an additional contact means to increase pivot strength of the measuring tool 95 relative to the bending rail 120. In other words, if pressure is applied upwardly or downwardly on the measuring tool 95, the recess 130 acts on the lip 125 to prevent disconnection between the measuring tool 95 and bending rail 120 without relying on the magnetic attraction between the magnet 110 and the strip 115.

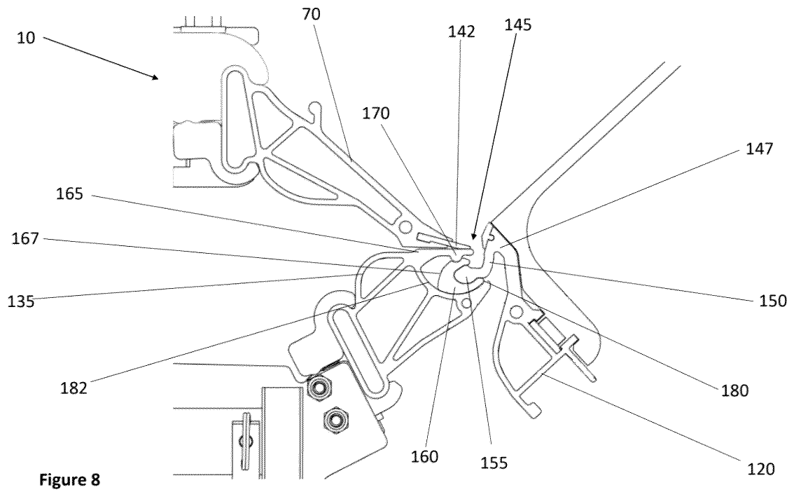

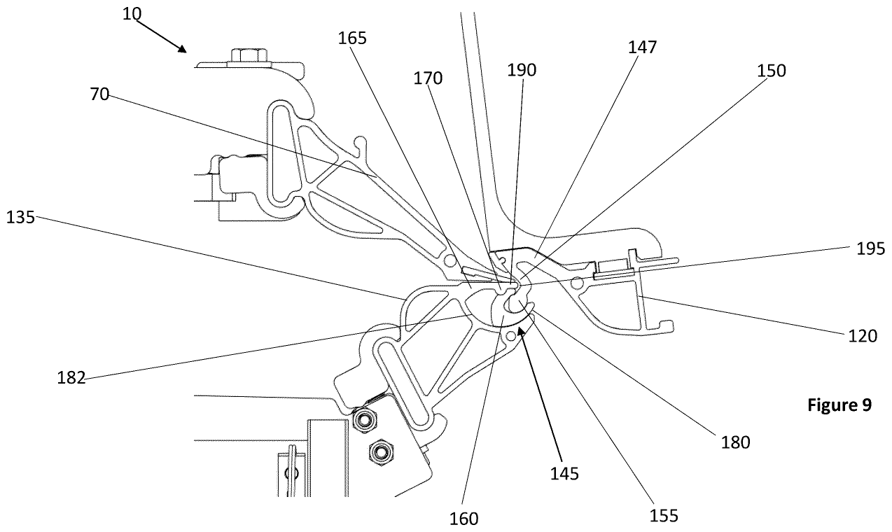

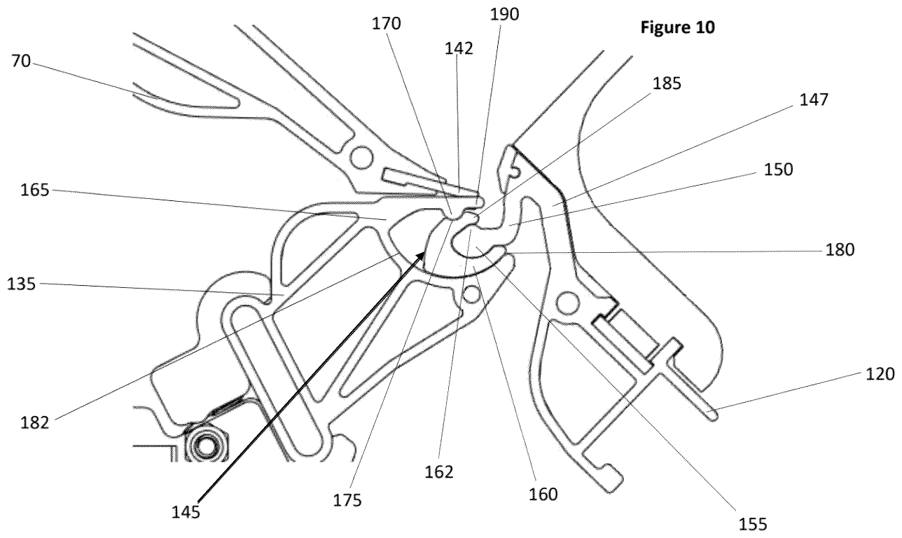

With reference to FIGS. 7, 8, 9 and 10 and according to an embodiment of the present disclosure, a base rail 135, bending rail 120 and locking rail 70 of the press brake 10 are shown interconnected in greater detail. The locking rail 70 is further comprised of a flat bar 142 having a notch, which may be constructed of steel due to the modularity of the press brake 10. In the prior art, the flat bar 142 is a thin piece of stainless steel sheet metal that slides over the aluminum extrusion; however, these thin sheets wear out and bend or break over time. The present flat bar 142, made of steel or stainless, is insertable directly into the extrusion 70 to give a more resistant edge and allows improved bending between the flat bar 142 and the upper edge of the female portion 165. As shown, a socket connection 145 is formed in between the bending rail 120 and the base rail 135. To form the socket connection 145, the bending rail 120 is comprised of a male portion 147, the male portion 147 further comprising a finger 150 terminating in a bulbous tip 155. The bulbous tip 155 is in turn inserted into a sleeve 160, the sleeve 160 being generally C-shaped to accommodate the shape of the bulbous tip 155. The sleeve 160 is preferably made of a friction resistant material. The bulbous tip 155 is further comprised of a bulge 162 to engage and pivot about a corresponding ridge (not shown) of the sleeve 160. The sleeve 160 is in turn inserted into a female portion 165 of the base rail 135. The female portion 165 is also generally C-shaped to accommodate the shape of the sleeve 160. The female portion 165 is further comprised of a nub 170, configured to be interconnected with and pivot about a recess 175 of the sleeve 160. A worker skilled in the art would appreciate that the base rail 135, bending rail 120 and locking rail 70 are made of extruded material. In other words, the bending rail 120 slides lengthwise into the sleeve 160, which in turn slides lengthwise into the base rail 135 to form the socket connection 145. Before bending of sheet metal, the press brake 10 is in a first position at rest, configured to accept a piece of sheet metal as specifically shown in FIG. 7. In this first position of the press brake 10, the sleeve 160 is positioned and trapped within the leftmost side of the female portion 165. In other words, an outer wall 167 of the sleeve 160 fits flushly against an inner wall 182 of the female portion 165. The finger 150 of the male portion 147 is also flushly against the inner wall 182 of the female portion 165. With specific reference to FIGS. 8 and 10, once the sheet metal has been positioned in the press brake 10 and is ready to be bent, an operator rotates the bending rail 120 counterclockwise relative to the base rail 135, which is static. During such rotation, the socket connection 145 is actuated and the sleeve 160 rotates relative to the female portion 165. The rotation of the sleeve 160 relative to the female portion 165 occurs about the pivot point created by the interconnection between the nub 170 of the female portion 165 and the recess 175 of the sleeve 160. During the rotation of the sleeve 160, a lower surface 180 of the outer wall 167 of the sleeve 160 slides along the upper surface 182 of the female portion 165. A worker skilled in the art would appreciate that the sleeve 160 has rotated maximally with respect to the female portion 165 when an upper segment 185 of the sleeve 160 abuts against a ledge 190 of the female portion 165. With specific reference to FIG. 9, the press brake 10 is shown in the second position whereby the sheet metal has been fully bent. In this second position, the sleeve 160 has been maximally rotated relative to the female portion 165. In a preferred embodiment, after the maximal rotation of the sleeve 160 relative to the female portion 165, the bulbous tip 155 of the male portion 147 begins rotating within the sleeve 160. The rotation occurs about the pivot point created by the interconnection between the bulge 162 of the bulbous tip 155 and the ridge (not shown) of the sleeve 160. The press brake 10 is fully bent and the socket connection 145 is maximally rotated once a depression 195 of the finger 150 abuts against the ledge 190, as shown in FIG. 9.

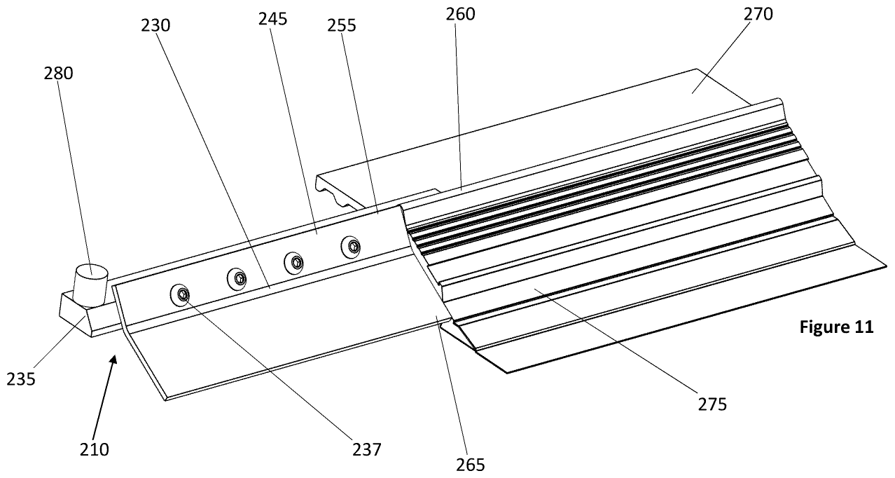

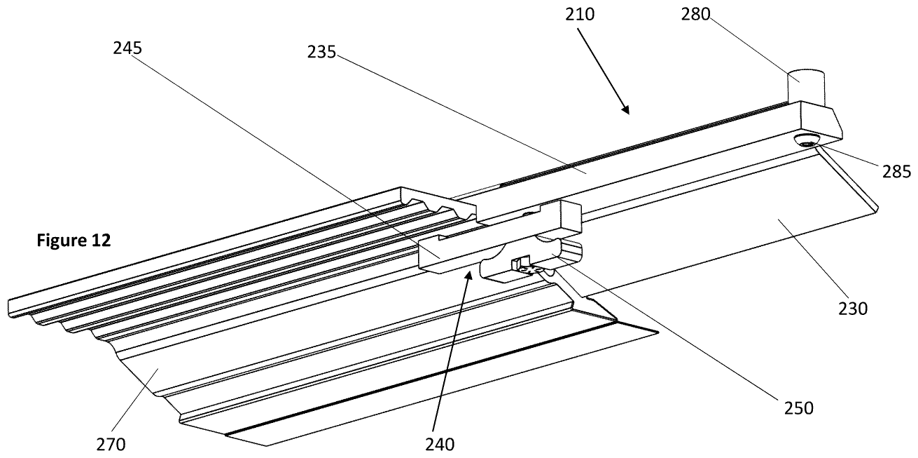

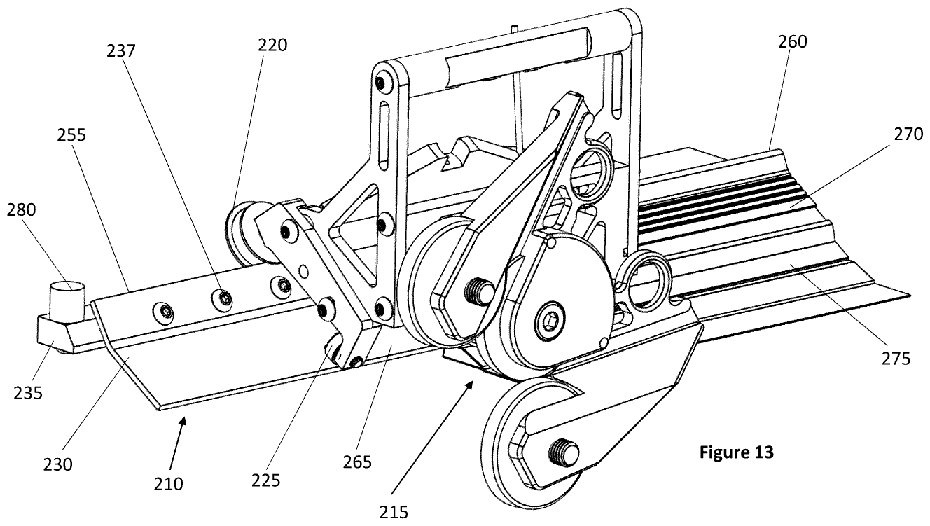

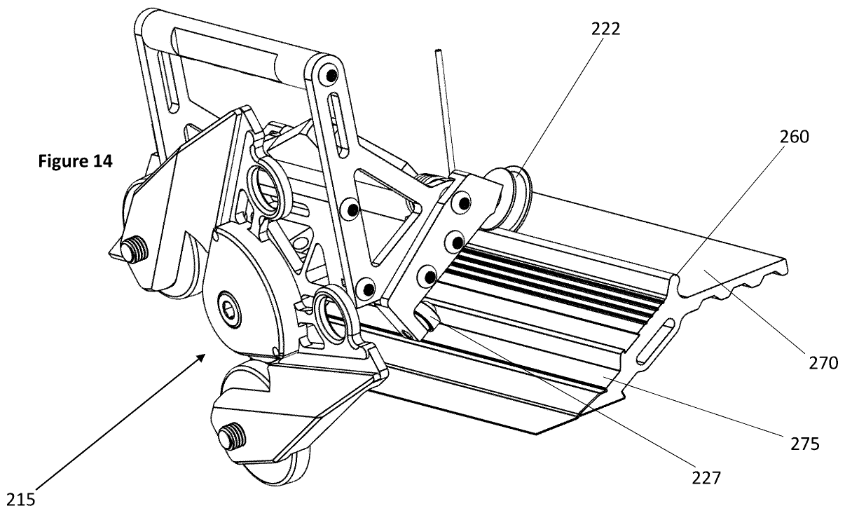

With reference to FIGS. 11, 12, 13 and 14 and according to an embodiment of the present disclosure, an extension 210 is shown removably secured to a locking rail 270 of a press brake (not shown). Cutters 215 are also shown, the cutters 215 utilized to cut sheet metal (not shown) positioned on the press brake (not shown). As shown, the cutters 215 can slide up and down the locking rail 270 and the extension 210 when the extension 210 is installed on the locking rail 270. The cutters 215 slide along the locking rail 270 by means of upper rollers 220, 222 and lower rollers 225, 227. The extension 210 is further comprised of a sheet member 230 secured to a bar 235 by means of screws 237. Together, the sheet member 230 and bar 235 are attached to the locking rail 270 by a fastener 240. In this particular embodiment, the fastener 240 is a C-shaped rod 245 tightened against the locking rail 270 and bar 235 by means of knob 250 or other similar means. A purpose of the fastener 240 is to ensure the sheet member 230 is positioned adjacent to the locking rail 270. As shown, an upper lip 255 of the sheet member 230 forms a generally continuous surface with an upper edge 260 of the locking rail 270. Meanwhile, a lower surface 265 of the sheet member 230 forms a generally continuous plane with the corresponding face 275 of the locking rail 270. Such continuous surface and continuous plane allow the upper rollers 220, 222 and lower rollers 225, 227 of the cutters 215 to slide along from the locking rail 270 to the extension 210 and back. A bumper 280 is also shown secured to the bar 235. In this particular embodiment, the bumper 280 is secured to the bar 235 by a bolt 285; however, the bumper 280 may be built into the extension 210 or secured by other securing means without departing from the scope of the disclosure. A purpose of the bumper 280 is to prevent the cutters 215 from sliding off the extension 210 and locking rail 270. Indeed, the upper roller 220 of the cutter 215 will abut against the bumper 280 when the cutters 215 have reached the end of the extension 210. A worker skilled in the art would appreciate that although the fastener 240 is a C-shaped rod 245 and knob 250, other fasteners 240 may be used, provided that they allow for the cutters 215 to move from the locking rail 270 onto the extension 210 and back unobstructed.

With reference to FIGS. 15, 16, 17 and 18 and according to an embodiment of the present disclosure, an extension 310 is shown removably secured to a locking rail 370 of a press brake (not shown). Cutters 315 are also shown, the cutters 315 utilized to cut sheet metal (not shown) positioned on the press brake (not shown). As shown, the cutters 315 can slide up and down the locking rail 370 and the extension 310 when the extension 310 is installed on the locking rail 370. The cutters 315 slide along the locking rail 370 by means of upper rollers 320, 322 and lower rollers 325, 327. The extension 310 is further comprised of a sheet member 330 secured to a bar 335 by means of screws 337. Together, the sheet member 330 and bar 335 are attached to the locking rail 370 by a fastener 340. In this particular embodiment, the fastener 340 is a C-shaped rod 345 tightened against the locking rail 370 and bar 335 by means of knob 350. A purpose of the fastener 340 is to ensure the sheet member 330 is positioned adjacent to the locking rail 370. As shown, an upper lip 355 of the sheet member 330 forms a generally continuous surface with an upper edge 360 of the locking rail 370. Meanwhile, a lower surface 365 of the sheet member 330 forms a generally continuous plane with the corresponding face 375 of the locking rail 370. Such continuous surface and continuous plane allow the upper rollers 320, 322 and lower rollers 325, 327 of the cutters 315 to slide along from the locking rail 370 to the extension 310 and back. A bumper 380 is also shown secured to the bar 335. In this particular embodiment, the bumper 380 is secured to the bar 335 by a bolt (not shown); however, the bumper 380 may be built into the extension 310 or secured by other securing means without departing from the scope of the disclosure. A purpose of the bumper 380 is to prevent the cutters 315 from sliding off the extension 310 and locking rail 370. Indeed, the upper roller 320 of the cutter 315 will abut against the bumper 380 when the cutters 315 have reached the end of the extension 310. A worker skilled in the art would appreciate that although the fastener 340 is a C-shaped rod 345 and knob 350, other fasteners 340 may be used, provided that they allow for the cutters 315 to move from the locking rail 370 onto the extension 310 and back unobstructed.

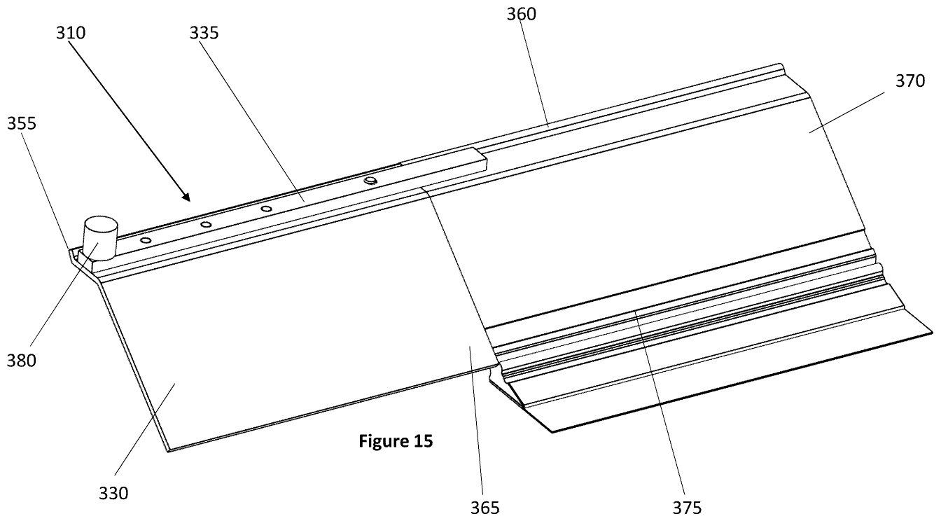

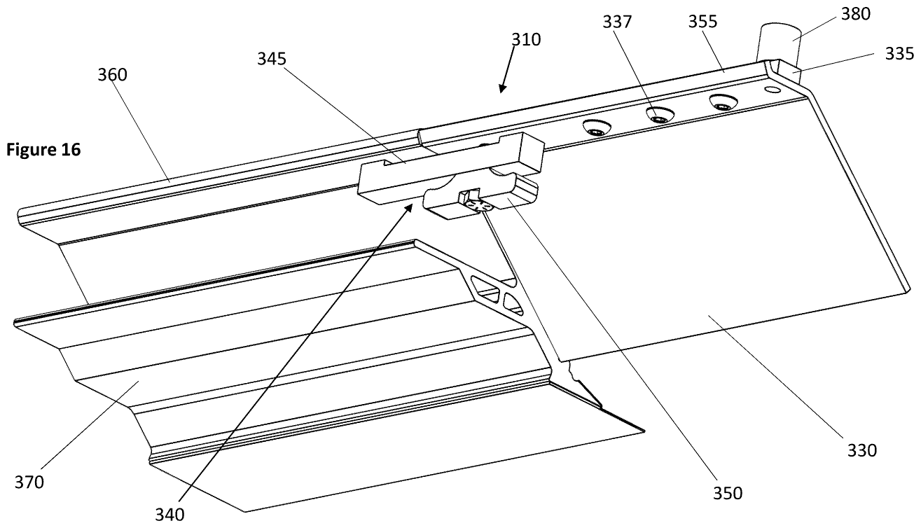

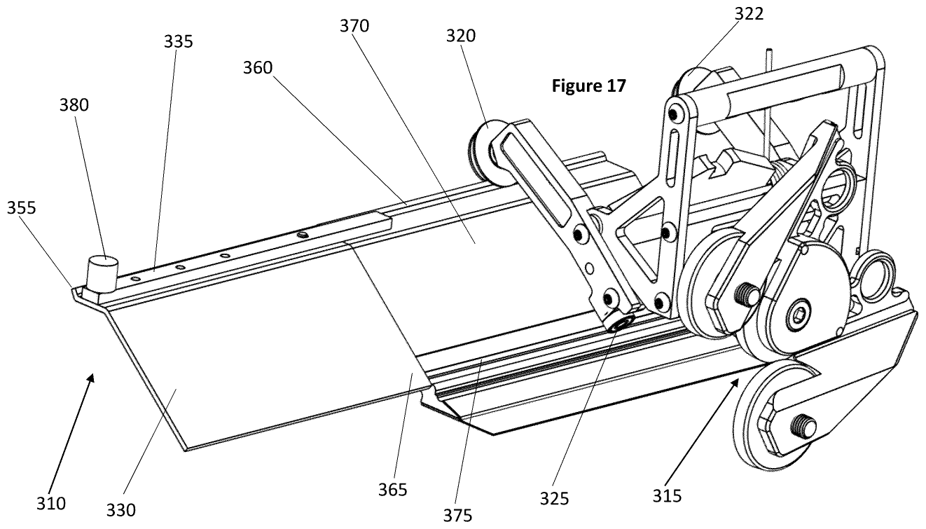

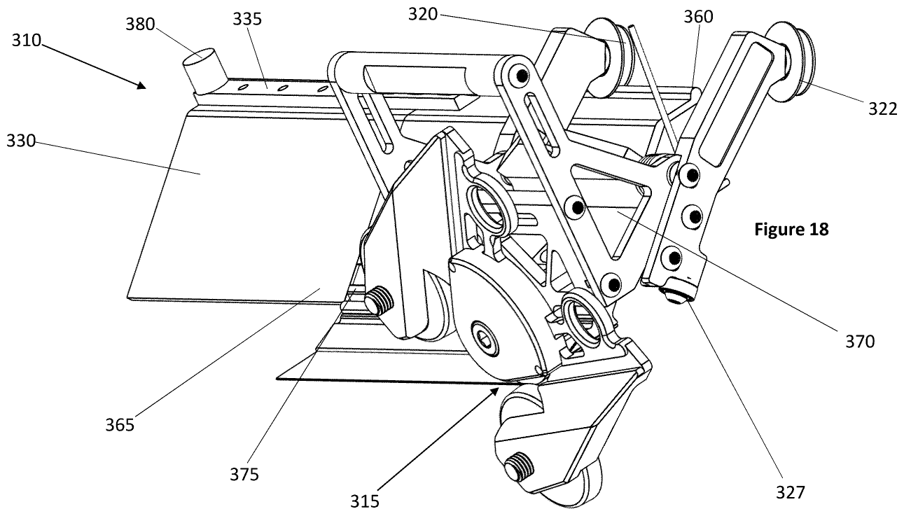

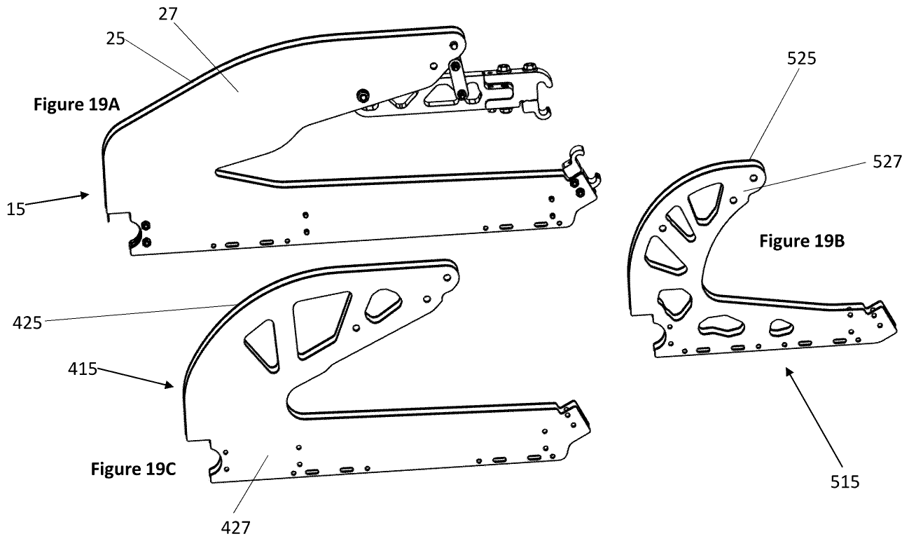

With reference to FIGS. 19A, 19B and 19C and according to another embodiment of the present disclosure, a variety of C-frames 15, 415, 515 are shown. An advantage of the present disclosure is that by fabricating the opposed plates 25, 27, 425, 427, 525, 527 as separate plates, a user can select different lengths of the C-frames 15, 415, 515 as desired. Offering a variety of depths of C-frames 15, 415, 515 is currently either impractical due to moulding costs.

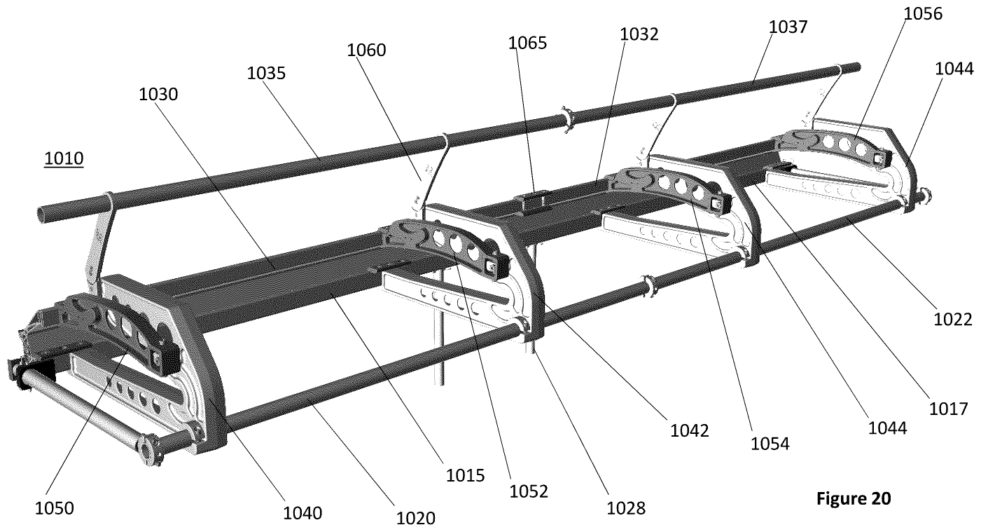

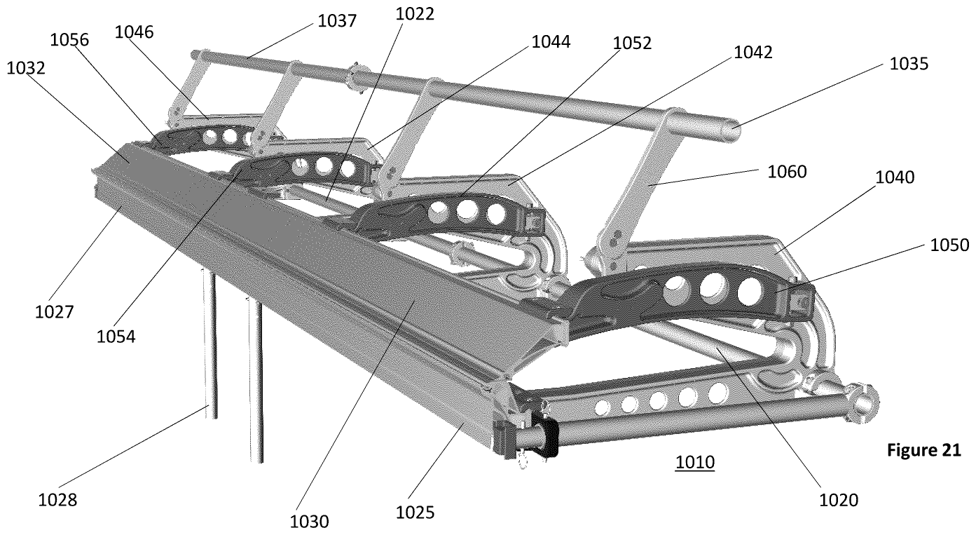

With reference to FIGS. 20 and 21, and according to an embodiment of the present disclosure, a modular press brake 1010 is shown, also known as a bending brake in the art. The press brake 1010 is further generally comprised of two base rails 1015, 1017 the base rails 1015, 1017 connected to secondary support bars 1020, 1022, which together support the brake 1010. A worker skilled in the art could appreciate that a support mechanism (not shown), such as foldable support legs having wheels, would be secured to the press brake 1010 to transport, move and otherwise maneuver the press brake 1010. Bending rails 1025, 1027 are also shown, the bending rails 1025, 1027 having a handle 1028 and operatively connected to the base rails 1015, 1017 for bending materials such as sheet metal. The press brake 1010 is also comprised of locking rails 1030, 1032 that are engageable with the bending rails 1025, 1027 and the base rails 1015, 1017. The locking rails 1030, 1032 are actuated by locking handles 1035, 1037 to lock the material in the brake 1010 before the material is bent. Four castings 1040, 1042, 1044, 1046 are shown slidable along the length of both the base rails 1015, 1017 and the support bars 1020, 1022. Each one of the castings 1040, 1042, 1044, 1046 is attached to corresponding stabilizing arms 1050, 1052, 1054, 1056, each one of the stabilizing arms 1050, 1052, 1054, 1056 also slidable along the length of the locking rails 1030, 1032. A worker skilled in the art would appreciate that during operation and to bend a material such as sheet metal, the material is inserted into the area in between the locking rails 1030, 1032 and the base rails 1015, 1017. The locking handles 1035, 1037 are then actuated, the locking handles 1035, 1037 either pushable or pullable depending on the configuration of the brake 1010. When the locking handles 1035, 1037 are pulled or pushed into place, the support arms 1060 pivot and correspondingly actuate the castings 1040, 1042, 1044, 1046 and the arms 1050, 1052, 1054, 1056 to press the locking rails 1030, 1032 downwardly against the material. The material is then locked into place, and an operator can manipulate the handle 1028 to bend the material as desired. A worker skilled in the art would appreciate that the press brake 1010 disclosed is modular, in that it can be of any desired length by adding or subtracting the number of parts along the length of the brake 1010. More specifically, although two base rails 1015, 1017, two support bars 1020, 1022, two bending rails 1025, 1027, two locking rails 1030, 1032 and two locking handles 1035, 1037 are shown, one a single part could be used or any number of such parts. Similarly, although four castings 1040, 1042, 1044, 1046 and four corresponding arms 1050, 1052, 1054, 1056 are shown, any number of castings or arms could be used and slid along the brake 1010. The modularity of the press brake 1010 allows for much simpler manufacturing of the brake 1010, easier and cheaper shipping, as well as simpler assembly. This modularity of the press brake 1010 further allows a brake 1010 depth of 24″, something that is not currently done in the prior art. Further, the ability to increase the number of castings 1040, 1042, 1044, 1046 allows for increased material gauge thickness capacity. Although solid castings are shown, a worker skilled in the art would appreciate that C-frames as describes herein could also be used.

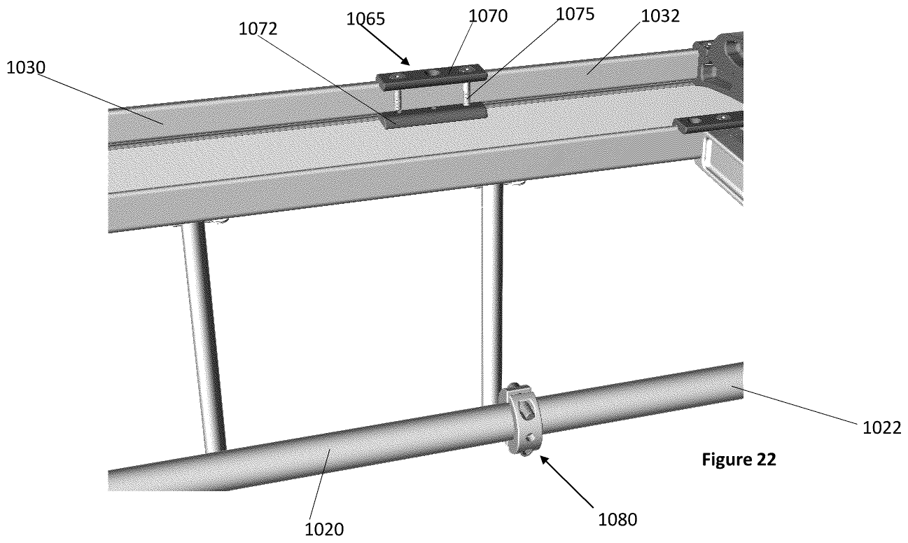

With reference to FIGS. 20 and 22 and according to an embodiment of the present disclosure, a clamp 1065 is shown comprised of upper and lower members 1070, 1072 tightened together in between bolts 1075. The upper and lower members 1070, 1072 have a groove (not shown) designed to fit over and around each side of the locking rails 1030, 1032. A purpose of the clamp 1065 is to connect the two adjacent locking rails 1030, 1032. A tri clamp 1080 is also shown tightened around the support bars 1020, 1022. Once again, a purpose of the tri clamp 1080 is to connect two adjacent support bars 1020, 1022. In this manner, any number of clamps or tri clamps can be used to connect adjacent rails or bars. In an alternate embodiment, the castings 1040, 1042, 1044, 1046 could be used to join and secure two adjacent rails 1030, 1032 or bars 1020, 1022. In such an alternate embodiment, at least one of the castings would need to be positioned between adjacent rails 1030, 1032 and bars 1020, 1022. In yet another embodiment, the locking rails 1030, 1032 have a dimple (not shown) and a corresponding aperture (not shown) to properly position the rails 1030, 1032 adjacent to one another. In yet another embodiment, the rails 1030, 1032 may have a shiplap type shape to properly mate adjacent one another.

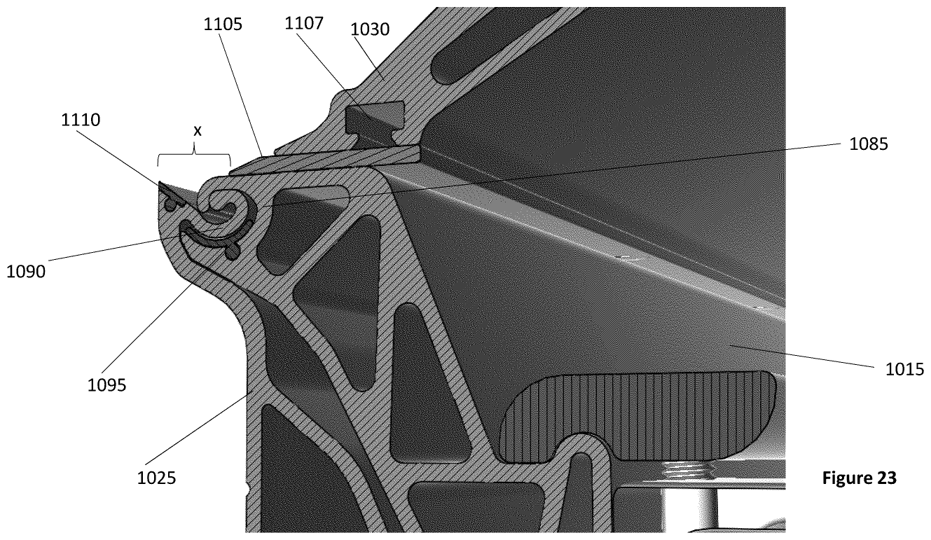

With reference to FIG. 23 and according to an embodiment of the present disclosure, the base rail 1015 is shown slid into the bending rail 1025. More specifically, each one of the base and bending rails 1015, 1025 are extruded in such a manner so as to fit into one another. The base rail 1015 has a claw portion 1085 to fit around a correspondingly shaped S-portion 1090 of the bending rail 1025. A friction pad 1095 is positioned in between the portions 1085, 1090 to prevent friction between the rails 1015, 1025. A fitting 1105 is also shown attached to the locking rail 1030 and positioned in between the locking rail 1030 and the base rail 1015. The fitting 1105 is preferably made of stainless steel to prevent wear on the material. A worker skilled in the art would appreciate that the locking rail 1030 is further comprised of a longitudinal cavity 1107 used to receive bolts (not shown) secured into the fitting 1105 so that the fitting 1105 can be slid into the locking rail 1030 and in between the base and locking rails 1015, 1030. A distance “x” is shown between fitting 1105 and an edge 1110 of the bending rail 1025, such distance being 0.5 inches. A worker skilled in the art would appreciate that brakes in the art have a larger corresponding distance of 0.75″. Indeed, the ability to have a smaller distance “x” is advantageous over the prior art as it allows for tighter bends of the material.

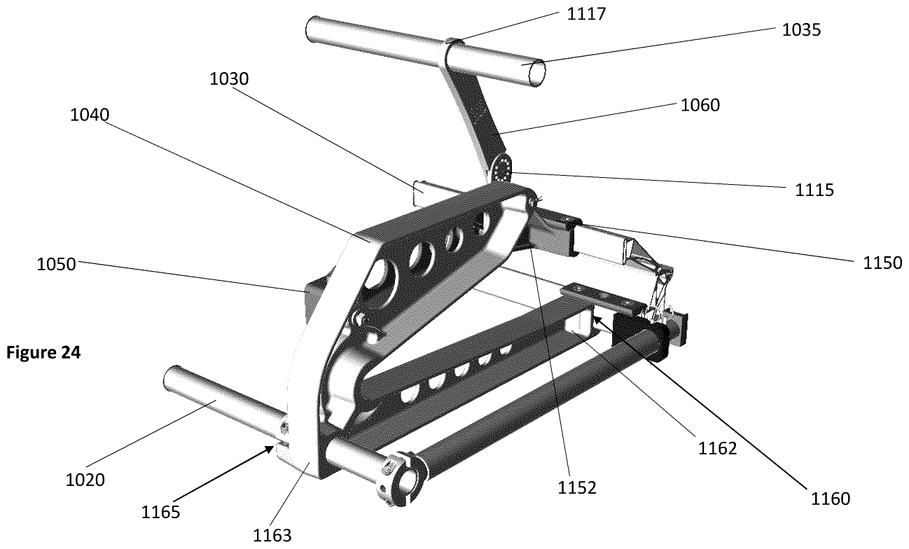

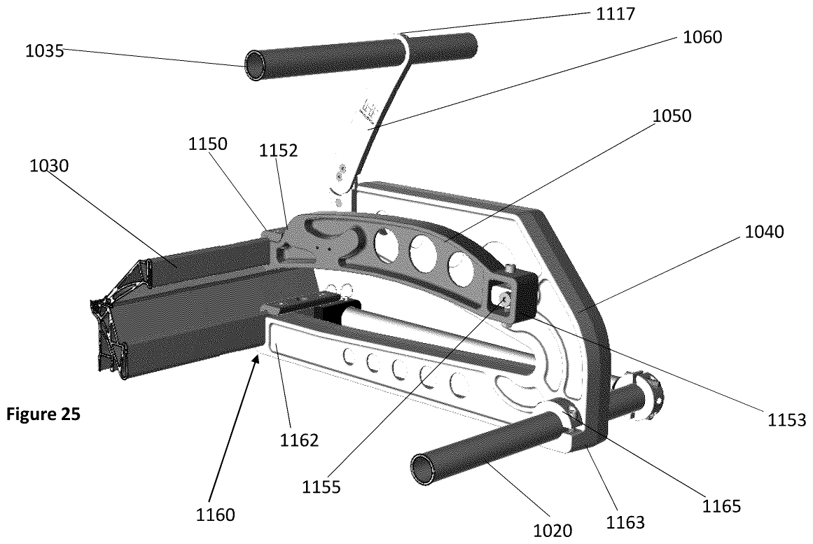

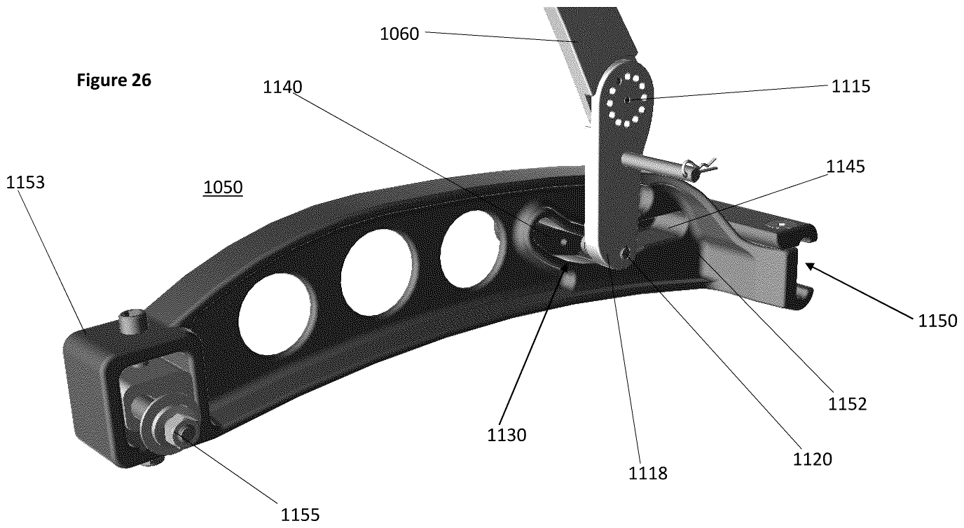

With reference to FIGS. 24, 25, 26 and 27 and according to an embodiment of the present disclosure, the casting 1040 and the stabilizing arm 1050 are shown in greater detail. The casting 1040 is engaged with both the locking handle 1035 and the stabilizing arm 1050 by means of support arm 1060. The support arm 1060 is pivotable about pivot point 1115 to an angle as desired by an operator of the brake. At a first end 1117, the support arm 1060 has an aperture (not shown) in which to fit the locking handle 1035. At a second end 1118, the support arm 1060 is sandwiched in between the casting 1040 and the stabilizing arm 1050 by means of a pin 1120. The pin 1120 is in turn secured within a hole 1125 of the casting 1040. The pin 1120 is also able to slide within a groove 1130 of the stabilizing arm 1050. During operation, a stopper (not shown) is positioned in one of the two apertures of the groove 1130, limiting the movement of the pin 1120 to a first side 1140 of the groove 1130, or a second side 1145 of the groove 1130. As shown, by confining the movement of the pin 1120 within either one of the sides 1140, 1145 of the groove 1130, an operator can pull or push the locking handle 1035. Indeed, it is an advantageous feature of the press brake that the locking handle 1035 can be either pulled or pushed to lock the material in the brake, which is a feature not currently possible in existing press brakes. The stabilizing arm 1050 is further comprised of a fastener 1150 at a first end 1152 that can clamp around the locking rail 1030. At a second end 1153, the stabilizing arm 1050 is secured to the casting 1040 by means of bolt 1155 or other attachment means known in the art. The casting 1040 is similarly comprised of a pincer 1160 at a first end 1162 that can clamp around the base rail 1015 and secure two adjacent base rails 1015, 1017. At a second end 1163, the casting 1040 is comprised of a modified tri clamp 1165 that is configured to receive the support bar 1020 of the brake. In this manner, both of the casting 1040 and the stabilizing arm 1050 are slidably adjustable along the press brake. As such, an operator can utilize any number of castings 1040 and stabilizing arms 1050 along the length of the brake 1010, making it more versatile.

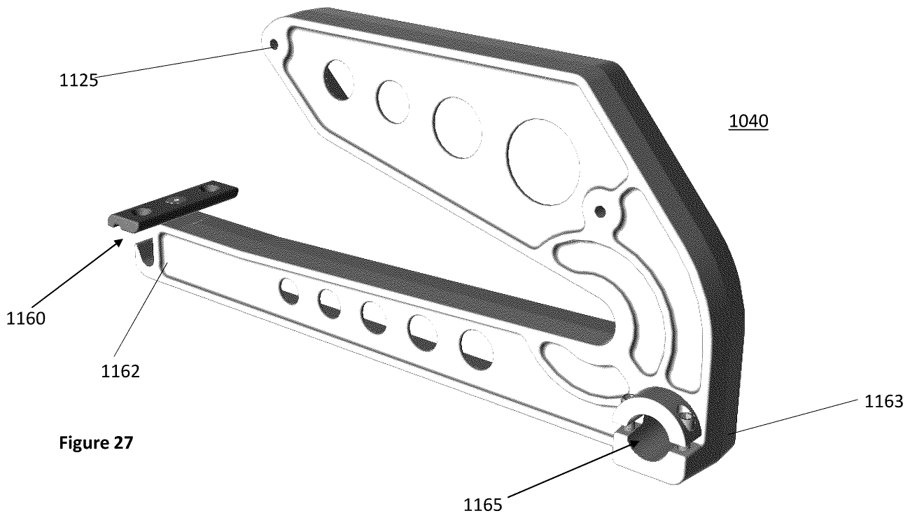

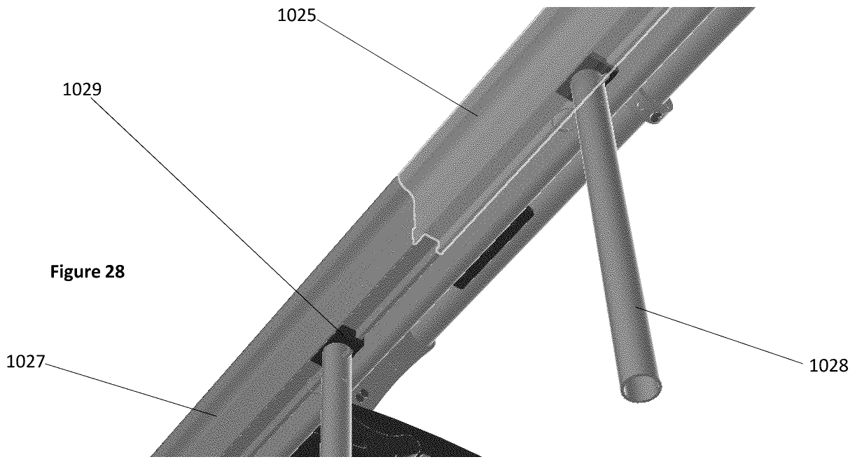

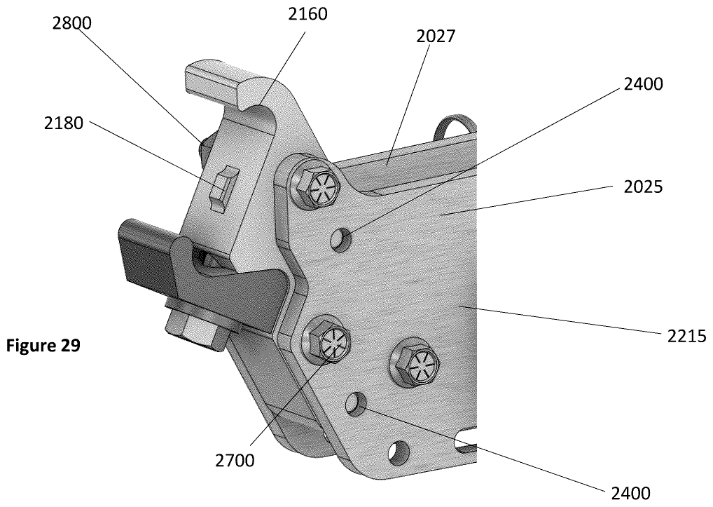

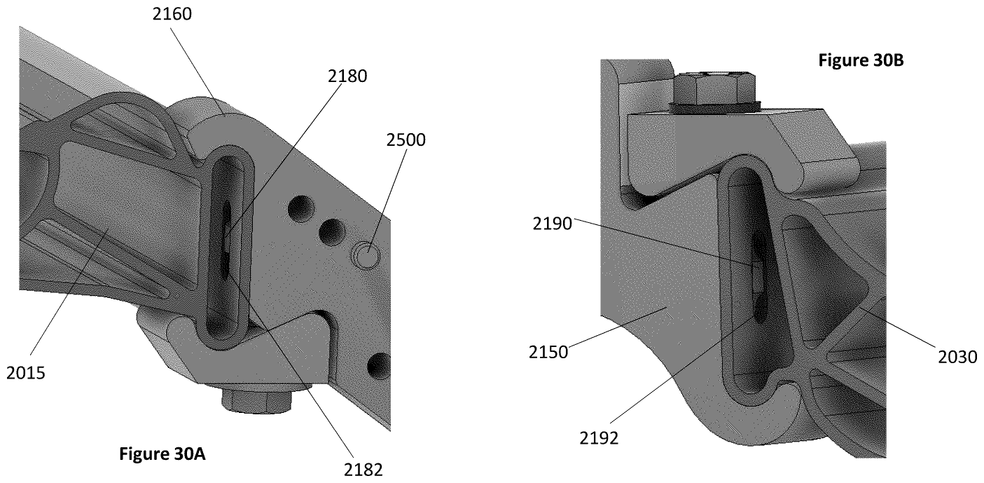

With further reference to FIGS. 21, 22, 24, 25 and 28 a worker skilled in the art would appreciate that in a preferred embodiment, the clamp 1065 and the tri clamp 1080 cooperate to secure adjacent locking rails 1030, 1032 and support bars 1020, 1022, respectively, thereby allowing the press brake 1010 to have any desired longitudinal length. However, in another embodiment, the press brake 1010 would not be comprised of clamp 1065 and tri clamp 1080 and would be replaced with fastener 1150 and modified tri clamp 1165 instead. In yet another embodiment, the support bars 1020, 1022 have a dimple (not shown) and a corresponding aperture (not shown) to properly position the support bars adjacent to one another. In yet another embodiment, the support bars 1020, 1022 may have a shiplap type shape to properly mate adjacent one another. Together, the fastener 1150 and modified tri clamp 1165 would cooperate to secure adjacent locking rails 1030, 1032 and support bars 1020, 1022, respectively. This also allows the press brake 1010 to have any desired longitudinal length and reduces the number of parts in the press brake 1010. In this alternate embodiment, the pincer 1160 is still utilized to secure adjacent base rails 1015, 1017. With specific reference to FIG. 28, two bending rails 1025, 1027 are shown interconnected one to the other. In this preferred embodiment, the handle 1028 has an engaging support 1029 and the engaging support 1029 would serve to secured the first bending rail 1025 to the second bending rail 1027. With reference to FIGS. 29, 30A and 30B and according to another embodiment of the present disclosure, the pincer 2160 and fastener 2150 are shown. To better align the pincer 2160 to the base rail 2015, the pincer 2160 may be comprised of a dimple 2180 to properly position the pincer 2160 into base rail 2015. The base rail 2015 has an aperture 2182 whose shape corresponds to that of the dimple 2180, which ensures proper positioning and alignment of the pincer 2160 relative to the base rail 2015. Similarly, to better align the fastener 2150 to the locking rail 2030, the fastener 2150 may be comprised of a dimple 2180 to properly position the fastener 2150 into the locking rail 2030. The locking rail 2030 has an aperture 2192 whose shape corresponds to that of the dimple 2190, which ensures proper positioning and alignment of the fastener 2150 relative to the locking rail 2030. As shown, the C-frame 2215 is further comprised of holes 2400 to facilitate the assembly of the C-frame 2215 by aligning the holes 2400 with a corresponding projection 2500 positioned on the pincer 2160. Indeed, in another method of assembly of the press brake (not shown), bolts 2700 are positioned on a lower end, and aligned with holes of the first plate 2025. The first plate 2025 is then positioned into the bolts 2700. The pincer 2160 and other spacing components (e.g. adjustment arm) have projections 2500 that are aligned with and positioned into the corresponding openings of the first plate 2025. In another step, the second plate 2027, having corresponding openings, is positioned over and through the projections 2500 of the pincer 2160 and other spacing components. Nuts 2800 are then threaded over bolts 2700, and the C-frame 2215 is assembled, as partially shown in FIG. 29. A worker skilled in the art would appreciate that in an alternate embodiment, the dimples or projections could be replaced with openings, and the openings could be replaced with dimples. In other words, as long as one piece can be aligned with and inserted into the other, which piece has the projection or dimple and opening is not important.

With reference to FIGS. 31A and 31B and according to another embodiment of the present disclosure, an alternate means to lock two adjacent rails is shown. More specifically, two adjacent locking rails 3070, 3072 are shown flushly mated to one another by means of connecting bars 3350, 3370. The connecting bars 3350, 3370 are slidable in the extruded locking rails 3070, 3072, the connecting bars 3350, 3370 further comprised of threaded holes 3400 and dimples 3500. The dimples 3500 fit into corresponding recesses (not shown) of the locking rails 3070, 3072 to properly align both the connecting bars 3350, 3370 within the locking rails 3070, 3072 but also the locking rails 3070, 3072 to each other. Once the locking rails 3070, 3072 are positioned flushly one adjacent to the other, the threaded holes 3400 become aligned with corresponding openings (not shown) of the locking rails 3070, 3072. Rivets or screws 3600 or other similar means are screwed through the openings (not shown) and into the threaded holes 3400 to lock the connecting bars 3350, 3370 to the locking rails 3070, 3072. A worker skilled in the art would appreciate that although locking rails 3070, 3072, the connecting bars 3350, 3370 may be used on any other rails of the press brake. In another embodiment, dimples may not be present and connecting bars are locked to rails by means of screws or other connecting means. Indeed, the modularity of the press brake may be achieved in a number of ways without departing from the scope of the disclosure; however, the optimal and preferred means have been described herein. The locking rails 3070, 3072 are further comprised of a longitudinal recess 3800 to receive the steel bar (shown in FIG. 7).

With reference to FIGS. 1 and 20, a worker skilled in the art would appreciate that both press brakes 10, 1010 are modular. Indeed, the rails and bars in each of the press brakes 10, 1010 are extruded or easily molded and can be secured to one another with fasteners as described.

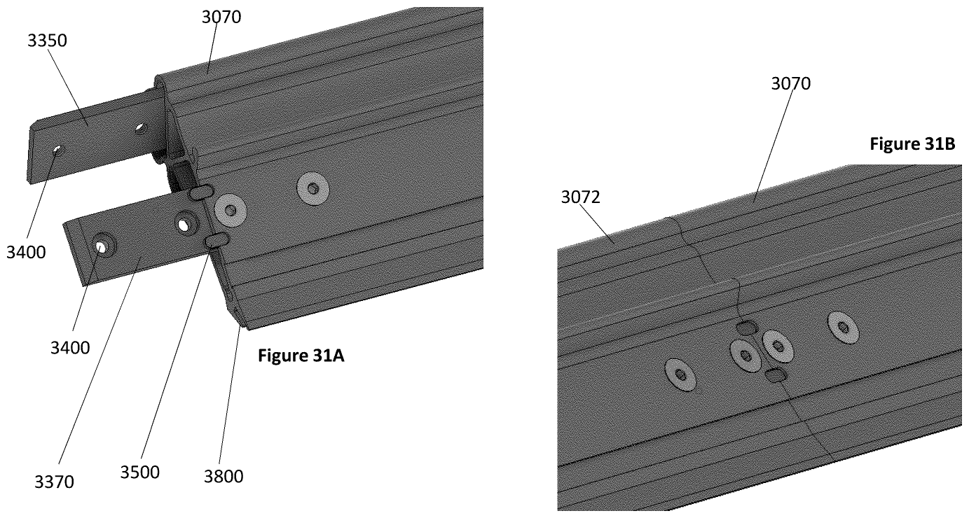

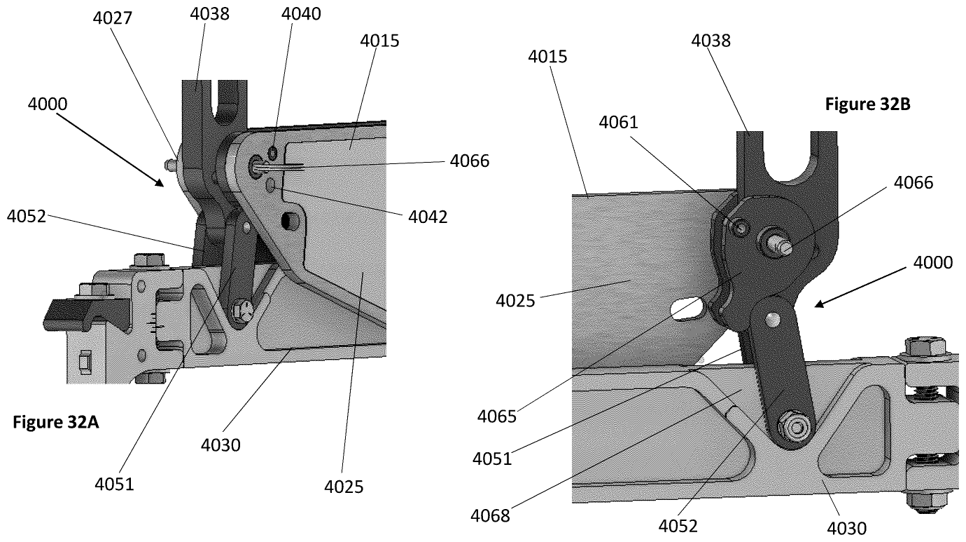

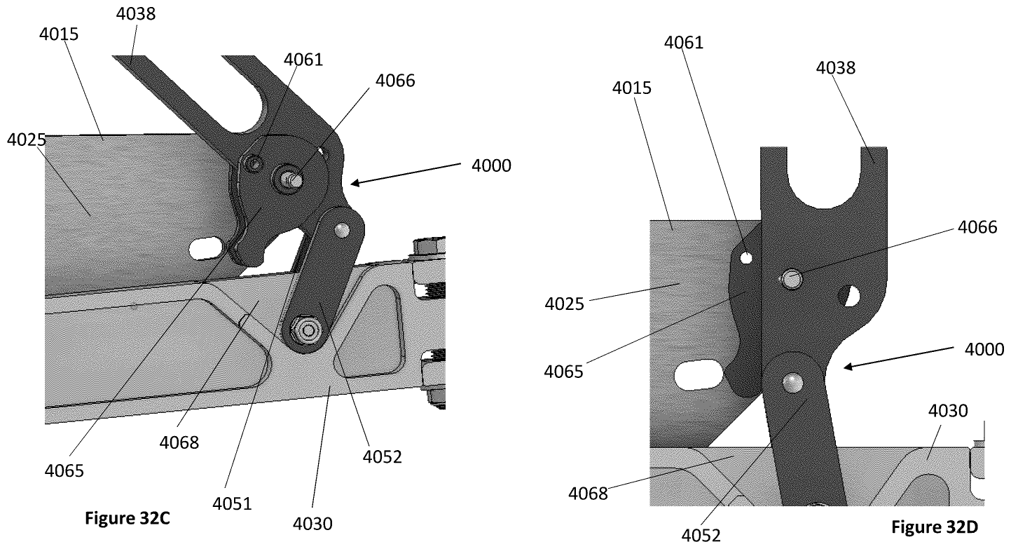

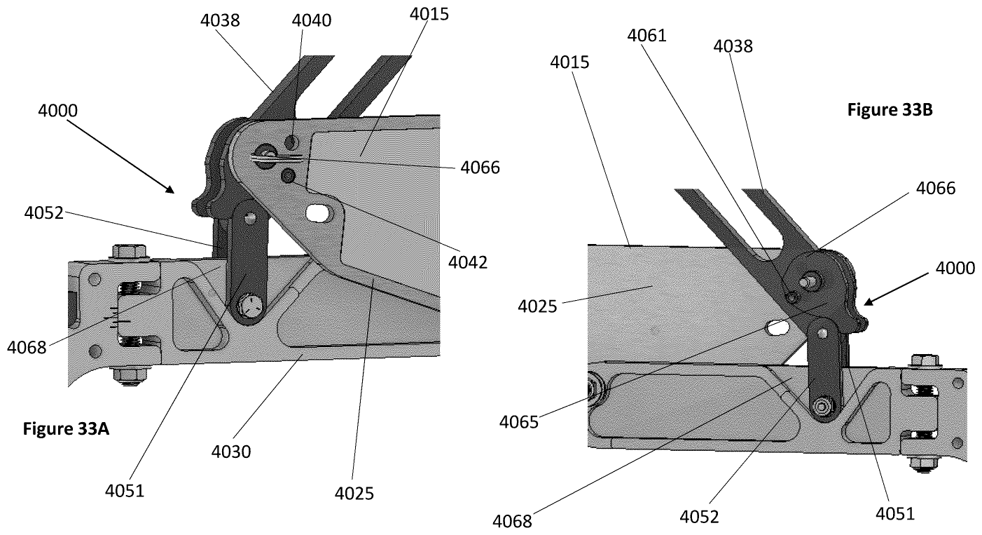

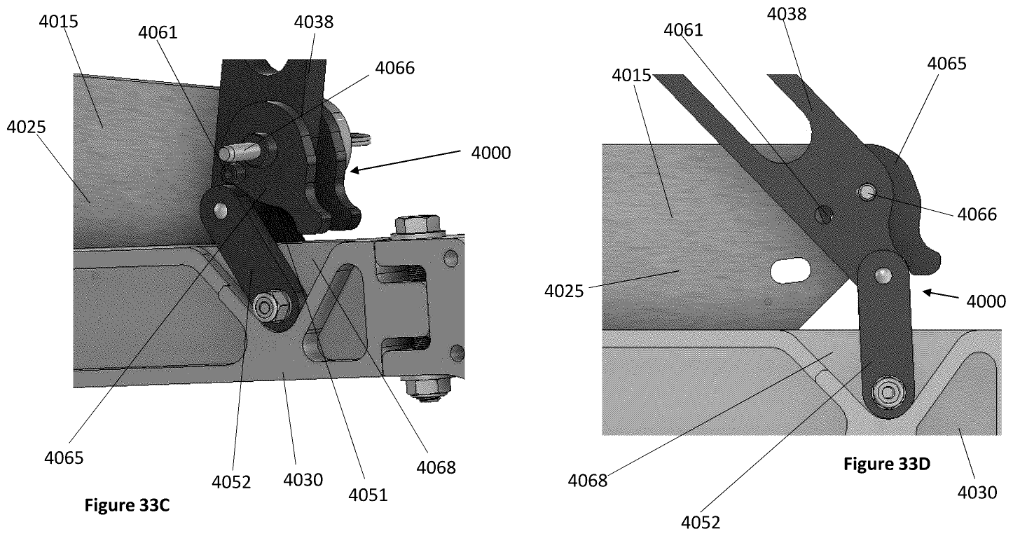

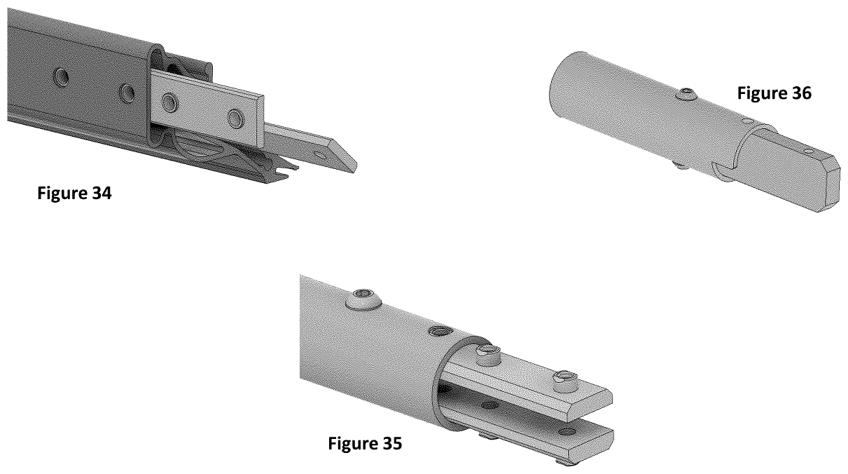

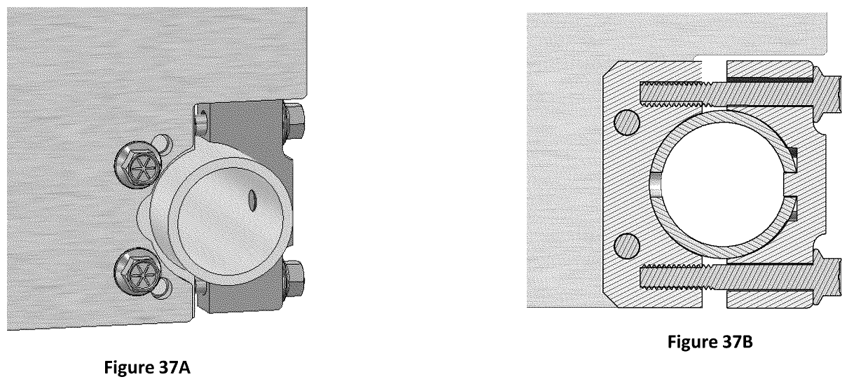

With reference to FIGS. 32A, 32B, 32C, 32D, 33A, 33B, 33C and 33D and according to an embodiment of the present disclosure, a reversible bending mechanism 4000 of the press brake (not shown) is shown. Indeed, a worker skilled in the art would appreciate that the locking arm 4038 must be pivoted in a single direction (either push or pull) to lock the press brake. However, with this reversible bending mechanism 4000, an operator can adjust the reversible bending mechanism 4000 so that the locking arm 4038 can be either pulled or pushed to lock the press brake (not shown). To do so, the opposed plates 4025, 4027 of the C-frame 4015 are further comprised of pivot-point openings 4040, 4042, through which a bolt (not shown) or other means can be inserted and set. Such bolt (not shown) would also be inserted through a corresponding opening 4061 of teardrop members 4065, the teardrop members 4065 attached to each side of the locking arm 4038 and the opposed plates 4025, 4027 by means of removeable pin 4066. The adjustment arm 4030 is comprised of angular recesses 4068 on each side of the adjustment arm 4030 to receive the first and second brackets 4051, 4052 of the locking arm 4038. During operation, the locking arm 4038 is either pushed or pulled, depending on the configuration, which will pivot the locking arm 4038 about pivot-point openings 4040, 4042. In turn, the first and second brackets 4051, 4052 will themselves pivot towards the front or rear of the angular recess 4068. A worker skilled in the art would appreciate that FIGS. 32A, 32B, 32C and 32D show the reversible bending mechanism 4000 in a pull-to-lock configuration, whereas FIGS. 33A, 33B, 33C and 33D show the reversible bending mechanism 4000 in a push-to-lock configuration. In the pull-to-lock configuration, the teardrop members 4065 are secured to the C-frame 4015 through pivot-point opening 4040, whereby a tip of the teardrop members 4065 is angled towards the C-frame 4015 to prevent the first and second brackets 4051, 4052 of the locking arm 4038 from pivoting towards one side of the angular recess 4068. In the push-to-lock configuration, the teardrop members 4065 are flipped over and secured to the C-frame 4015 through pivot-point opening 4042, whereby a tip of the teardrop members 4065 is now angled away from the C-frame 4015 (in a flipped position relative to the pull-to-lock configuration) to prevent the first and second brackets 4051, 4052 of the locking arm 4038 from pivoting towards the other side of the angular recess 4068.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A press brake comprising:
at least one base rail;
at least one bending rail operatively connected to the at least one base rail for bending materials;
at least one locking rail engageable with the bending rail to lock the material in the press brake;
at least two castings releasably secured to the at least one base rail and at least one support bar;
an arm secured to each one of the at least two castings and connecting the at least two castings to the at least one locking rail;
a locking handle connected to each one of the at least two castings, the locking handle actuatable to lock the press brake; and,
a socket connection between the base rail and the bending rail.

2. The modular press brake of claim 1 wherein the at least one base rail, bending rail, locking rail and support bar are adapted to be secured to an adjacent base rail, bending rail, locking rail and support bar to increase a length of the modular press brake.

3. The modular press brake of claim 2 further comprised of a connector to lock at least one of:
the at least one base rail to the adjacent base rail;
the at least one bending rail to the adjacent bending rail;
the at least one locking rail to the adjacent locking rail; and,
the at least one support bar to the adjacent support bar.

4. The modular press brake of claim 3 wherein the connector is at least one of: a tri-clamp, a clamp member, a fastener and a connecting bar.

5. The modular press brake of claim 3 wherein the connector is further comprised of one of a dimple and an opening configured to fit into one of an aperture or a projection of the base rail, bending rail, locking rail and support bar, to position the connector to at least one of the base rail, bending rail, locking rail and support bar.

6. The modular press brake of claim 1 wherein the at least two castings are further comprised of first adjustable fasteners, and wherein the arm is further comprised of a second adjustable fastener, the first adjustable fasteners configured to be loosened and tightened along the at least one base rail and the at least one support bar, the second adjustable fastener configured to be loosened and tightened along the at least one locking rail, the first and second adjustable fasteners to slide the at least two castings to fixed positions along the modular press brake.

7. The modular press brake of claim 1 wherein the at least two castings are further comprised of two opposed plates secured to one another, the two opposed plates to facilitate transportation and serviceability of the modular press brake.

8. The modular press brake of claim 1 wherein the socket connection is further comprised of a male portion, a sleeve and a female portion.

9. The modular press brake of claim 8 wherein the sleeve and the male portion pivot about a first point relative to the female portion, and the male portion pivots about a second point relative to the sleeve and the female portion.

10. The modular press brake of claim 8 wherein the male portion is a finger terminating in a bulbous tip.

11. The modular press brake of claim 8 wherein the female portion is comprised of a longitudinal nub configured to fit into and pivot about a recess of the sleeve.

12. The modular press brake of claim 8 wherein the male portion is shaped to mate flushly into the sleeve, and the sleeve is shaped to mate flushly into the female portion.

13. The modular press brake of claim 1 wherein the arm is one of: a stabilizing arm and an adjustment arm.

14. The modular press brake of claim 1 wherein the locking handle is lockable in an operating position and pivotable from the operating position to a locked position, wherein the operating position is to operate the press brake and the locked position is to store and transport the press brake.

15. The modular press brake of claim 1 wherein the locking rail is further comprised of longitudinal recess to receive a flat bar.

16. The modular press brake of claim 1 further comprised of a reversible bending mechanism to adapt the locking handle to pivot from either one of: a first position to a second position, and the second position to the first position, to lock the press brake.

17. The modular press brake of claim 16 further comprised of:
two teardrop members secured to the C-frame and the locking handle; and,
a first and second bracket pivotally connected to the locking handle,
wherein the teardrop members are comprised of two pivot-point openings to adapt the locking handle.

18. A method to assemble a casting, the method comprising the steps of:
aligning apertures of a first plate of the casting with bolts and placing the first plate on the bolts through the apertures;
aligning first projections of spacers, an adjustment arm and a locking arm, over the first plate and inserting the projections of the spacers, the adjustment arm and the locking arm through receiving openings of the spacers, adjustment arm and locking arm;
aligning holes of a second plate of the casting with second opposed projections of the spacers, the adjustment arm and the locking arm and inserting the second opposed projections into the holes to properly position the second plate;
securing the bolts with a fastener to sandwich the spacers, the adjustment arm and the locking arm into place.

19. A stopper for use with a press brake comprising:
a clamp to slidably secure the stopper to the press brake;
a rail pivotably connected to the clamp; and,
a stopping member slidable along the rail,
wherein the stopping member can be pivoted with the rail to prevent obstruction of a material in the press brake.
